(19) United States
(12) Patent Application Publication
(10) Pub. No.: US 2023/0387545 A1
(43) Pub. Date: Nov. 30, 2023

(54) NONAQUEOUS ELECTROLYTE SECONDARY BATTERY LAMINATED SEPARATOR

(71) Applicant: Sumitomo Chemical Company, Limited, Tokyo (JP)

(72) Inventors: Riku MATSUMINE, Niihama-shi (JP); Yoshinori SATO, Niihama-shi (JP)

(21) Appl. No.: 18/324,224

(22) Filed: May 26, 2023

(30) Foreign Application Priority Data
May 27, 2022 (JP) 2022-087130
Jun. 30, 2022 (JP) 2022-106287
Dec. 8, 2022 (JP) 2022-196636

(51) Int. Cl. H01M 50/417; H01M 50/42; H01M 50/463

(52) U.S. Cl. CPC H01M 50/417; H01M 50/42; H01M 50/463

(57) ABSTRACT

Provided is a nonaqueous electrolyte secondary battery laminated separator which achieves both of voltage resistance and ion permeability. A nonaqueous electrolyte secondary battery laminated separator (4a) having a heat-resistant layer (2a, 2b) on one surface or both surfaces of a polyolefin-based base material (1) includes a particle layer (3a, 3b) on at least one side of the laminated separator, the particle layer containing particles having an average particle diameter of 3 μm to 10 μm, and the particle layer having a weight per unit area per layer of 0.1 g/m² to 1.0 g/m².

This Nonprovisional application claims priority under 35 U.S.C. § 119 on Patent Application No. 2022-106287 filed in Japan on Jun. 30, 2022, Patent Application No. 2022-087130 filed in Japan on May 27, 2022, and Patent Application No. 2022-196636 filed in Japan on Dec. 8, 2022, the entire contents of which are hereby incorporated by reference.

### TECHNICAL FIELD

The present invention relates to a laminated separator for a nonaqueous electrolyte secondary battery (hereinafter referred to as a “nonaqueous electrolyte secondary battery laminated separator”).

### BACKGROUND ART

Nonaqueous electrolyte secondary batteries, particularly lithium ion secondary batteries, have a high energy density, and are therefore widely used as batteries for personal computers, mobile telephones, portable information terminals, cars, and the like. A lithium ion battery generally includes a separator between a positive electrode and a negative electrode. For example, Patent Literature 1 discloses: a porous film that has, on at least one surface of a porous base material, a heat-resistant layer which contains inorganic particles and a heat-resistant resin; a secondary battery separator that employs the porous film; and a secondary battery that includes the secondary battery separator.

### CITATION LIST

### Patent Literatures

### [Patent Literature 1]

International Publication No. WO 2018/155288

### SUMMARY OF INVENTION

### Technical Problem

In recent years, batteries have advanced to have larger cells, and further improvement in safety of such batteries is required. However, in view of voltage resistance, there has been room for further improvement of a separator that uses a conventional heat-resistant layer as disclosed in Patent Literature 1.

An object of an aspect of the present invention is to provide an electrolyte secondary battery laminated separator which achieves both of voltage resistance and ion permeability.

### Solution to Problem

In order to solve the above problem, a nonaqueous electrolyte secondary battery laminated separator in accordance with an aspect of the present invention is:
a nonaqueous electrolyte secondary battery laminated separator having a heat-resistant layer on one surface or both surfaces of a polyolefin-based base material, the nonaqueous electrolyte secondary battery laminated separator including
a particle layer on at least one side of the laminated separator,
the particle layer containing particles having an average particle diameter of 3 μm to 10 μm, and the particle layer having a weight per unit area per layer of 0.1 g/m² to 1.0 g/m².

### Advantageous Effects of Invention

An aspect of the present invention provides a laminated separator excellent in both voltage resistance and ion permeability.

### BRIEF DESCRIPTION OF DRAWINGS

FIG. 1 is a schematic diagram illustrating an example structure of a nonaqueous electrolyte secondary battery laminated separator in accordance with an aspect of the present invention.

FIG. 2 is a schematic diagram illustrating an example structure of a nonaqueous electrolyte secondary battery laminated separator in accordance with an aspect of the present invention.

FIG. 3 is a schematic diagram illustrating an example structure of a nonaqueous electrolyte secondary battery laminated separator in accordance with an aspect of the present invention.

FIG. 4 is a schematic diagram illustrating an example structure of a nonaqueous electrolyte secondary battery laminated separator in accordance with an aspect of the present invention.

FIG. 5 is a schematic diagram illustrating an example structure of a nonaqueous electrolyte secondary battery laminated separator in accordance with an aspect of the present invention.

FIG. 6 is a cross-sectional view schematically illustrating an example structure of a particle that is contained in a particle layer in accordance with an embodiment of the present invention.

FIG. 7 is a schematic diagram illustrating the shape of a cylindrical electrode probe of a withstand voltage tester that was used in measurement of voltage resistance in Examples of the present application.

### DESCRIPTION OF EMBODIMENTS

The following description will discuss embodiments of the present invention. Note, however, that the present invention is not limited to the embodiments. The present invention is not limited to arrangements described below, but may be altered in various ways by a skilled person within the scope of the claims. The present invention also encompasses, in its technical scope, any embodiment derived by combining technical means disclosed in differing embodiments. Any numerical range expressed as “A to B” herein means “not less than A and not more than B” unless otherwise stated.

1. Nonaqueous Electrolyte Secondary Battery Laminated Separator

In a conventional technique of a separator that is used in a nonaqueous electrolyte secondary battery, the separator has an uneven surface and has a smaller thickness at a depressed portion. For this reason, such a separator has low voltage resistance. Therefore, as described above, there has been room for improvement of the conventional technique in terms of voltage resistance.

In order to solve the above problems, the inventors of the present invention have made diligent studies. As a result, the inventors have first found that with regard to a nonaqueous electrolyte secondary battery laminated separator (hereinafter, also simply referred to as “laminated separator” or “separator”) having: a heat-resistant layer on one surface or both surfaces of a polyolefin-based base material; and a particle layer on at least one side of the laminated separator, it is possible to obtain a laminated separator excellent in voltage resistance when the particle layer contains particles having an average particle diameter of 3 μm to 10 μm and it is possible to obtain a laminated separator excellent in ion permeability when the particle layer has a weight per unit area per layer of 0.1 g/m² to 1.0 g/m.

A nonaqueous electrolyte secondary battery laminated separator in an aspect of the present invention can achieve both of voltage resistance and ion permeability, and has improved safety as compared to the separator of the conventional technique.

[1.1. Configuration of Nonaqueous Electrolyte Secondary Battery Laminated Separator]

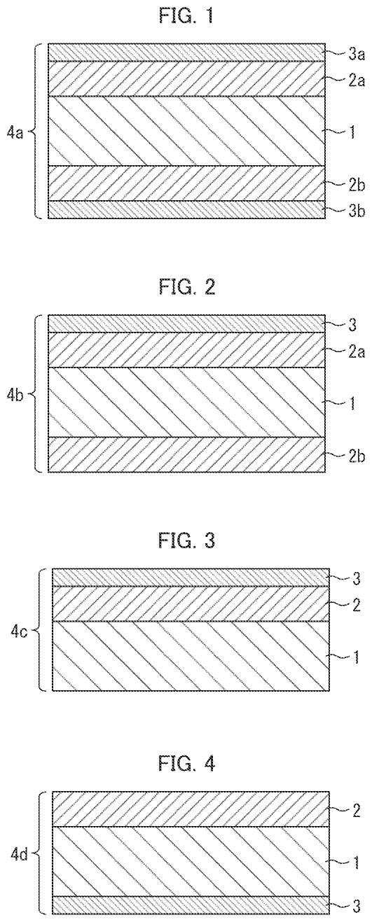

A laminated separator in accordance with an embodiment of the present invention has a heat-resistant layer on one surface or both surfaces of a polyolefin-based base material, and further has a particle layer on at least one side of the laminated separator. In the laminated separator, the particle layer may be provided at a surface of the laminated separator, or another layer may be further provided on the particle layer. The following will specifically discuss configurations of the laminated separator with reference to FIGS. 1 to 5.

As shown in FIG. 1, in an embodiment, a laminated separator 4a includes a polyolefin-based base material 1, heat-resistant layers 2a and 2b which are provided on both surfaces of the polyolefin-based base material 1, and particle layers 3a and 3b which are provided on surfaces on both sides of the laminated separator 4a.

Further, as shown in FIG. 2, in an embodiment, a laminated separator 4b includes a polyolefin-based base material 1, heat-resistant layers 2a and 2b which are provided on both surfaces of the polyolefin-based base material 1, and a particle layer 3 which is provided on a surface on one side of the laminated separator 4b.

Further, as shown in FIG. 3, in an embodiment, a laminated separator 4c includes a polyolefin-based base material 1, a heat-resistant layer 2 which is provided on one surface of the polyolefin-based base material 1, and a particle layer 3 which is provided on a surface of the laminated separator 4c on a side where the heat-resistant layer 2 is provided.

In addition to the above configurations, as shown in FIG. 4, in an embodiment, a laminated separator 4d includes a polyolefin-based base material 1, a heat-resistant layer 2 which is provided on one surface of the polyolefin-based base material 1, and a particle layer 3 which is provided on a surface of the laminated separator 4d on a side where no heat-resistant layer is provided.

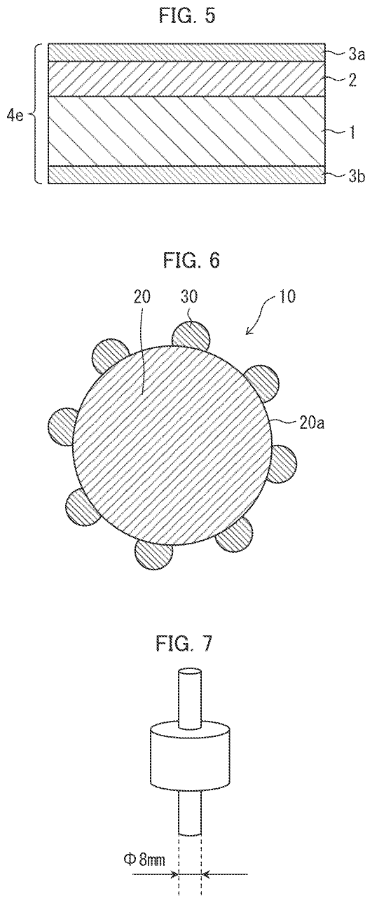

Further, in addition to the above configurations, as shown in FIG. 5, in an embodiment, a laminated separator 4e includes a polyolefin-based base material 1, a heat-resistant layer 2 which is provided on one surface of the polyolefin-based base material 1, and particle layers 3a and 3b which are provided on both surfaces on both sides of the laminated separator 4e.

[1.2. Polyolefin-Based Base Material]

A laminated separator in accordance with an embodiment of the present invention includes a polyolefin-based base material. As used herein, the term “polyolefin-based base material” refers to a base material that contains a polyolefin-based resin as a main component. Further, the phrase “contain a polyolefin-based resin as a main component” means that the polyolefin-based resin is contained, in the base material, at a proportion of not less than 50% by weight, preferably not less than 90% by weight, and more preferably not less than 95% by weight with respect to all materials that constitute the base material.

The polyolefin-based base material contains a polyolefin-based resin as a main component, and has therein many pores connected to one another. This allows gas and liquid to pass through the polyolefin porous film from one surface to the other. Note that, hereinafter, the polyolefin-based base material is also simply referred to as “base material”.

The polyolefin preferably contains a high molecular weight component having a weight-average molecular weight of 5×10⁵ to 15×10⁶. In particular, the polyolefin more preferably contains a high molecular weight component having a weight-average molecular weight of not less than 1,000,000 because the strength of the nonaqueous electrolyte secondary battery laminated separator in accordance with an embodiment of the present invention improves.

Examples of the polyolefin include homopolymers and copolymers which are each obtained by polymerizing a monomer(s) such as ethylene, propylene, 1-butene, 4-methyl-1-pentene, 1-hexene, and/or the like.

Examples of such homopolymers include polyethylene, polypropylene, and polybutene. Meanwhile, examples of the copolymers include an ethylene-propylene copolymer.

Among the above polyolefins, polyethylene is preferable as the polyolefin because it is possible to prevent a flow of an excessively large electric current at a lower temperature. Note that the phrase “to prevent a flow of an excessively large electric current” is also referred to as “shutdown”.

Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these polyethylenes, the polyethylene is preferably ultra-high molecular weight polyethylene having a weight-average molecular weight of not less than 1,000,000.

The weight per unit area of the base material can be set as appropriate in view of strength, thickness, weight, and handleability. Note, however, that the weight per unit area of the base material is preferably 2 g/m² to 20 g/m², more preferably 2 g/m² to 12 g/m², and still more preferably 3 g/m² to 10 g/m², so as to allow the nonaqueous electrolyte secondary battery to have a higher weight energy density and a higher volume energy density.

The base material has an air permeability of preferably 30 s/100 mL to 500 s/100 mL, and more preferably 50 s/100 mL to 300 s/100 mL, in terms of Gurley values. A base material having an air permeability in the above range can achieve sufficient ion permeability.

The base material has a porosity of preferably 20% by volume to 80% by volume, and more preferably 30% by volume to 75% by volume, so as to (i) retain a larger amount of an electrolyte and (ii) obtain the function of reliably preventing a flow of an excessively large electric current at a lower temperature.

Further, in order to achieve sufficient ion permeability and prevent particles from entering the positive electrode and/or the negative electrode, the base material has pores each having a pore diameter of preferably not more than 0.3 μm, and more preferably not more than 0.14 μm.

The base material has a thickness of preferably not less than 4 μm, more preferably not less than 5 μm, and still more preferably not less than 6 μm (lower limit). The base material has a thickness of preferably not more than 29 μm, more preferably not more than 20 μm, and still more preferably not more than 15 μm (upper limit). Examples of a combination of the lower limit and the upper limit of the thickness of the base material include 4 μm to 29 μm, 5 μm to 20 μm, and 6 μm to 15 μm.

[1.3. Heat-Resistant Layer]

The laminated separator in accordance with an embodiment of the present invention includes a heat-resistant layer on one or both surfaces of the polyolefin-based base material. The heat-resistant layer contains a heat-resistant resin. It is preferable that the resin be insoluble in the electrolyte of the battery and, when the battery is in normal use, be electrochemically stable.

Examples of the resin include: polyolefins; (meth)acrylate-based resins; aromatic resins; fluorine-containing resins; polyamide-based resins; polyimide-based resins; polyester-based resins; rubbers; resins each having a melting point or a glass transition temperature of not lower than 180° C.; water-soluble polymers; polycarbonate; polyacetal; and polyether ether ketone.

Among the above resins, one or more resins selected from the group consisting of polyolefins, (meth)acrylate-based resins, fluorine-containing resins, aromatic resins, polyamide-based resins, polyester-based resins and water-soluble polymers are preferable.

The resin is more preferably aromatic resins. Further, among the aromatic resins, nitrogen-containing aromatic resins are particularly preferable. Furthermore, among the nitrogen-containing aromatic resins, aramid resins (described later) are most preferable. The aromatic resins are excellent in heat resistance since the nitrogen-containing aromatic resins include a bond via nitrogen, such as an amide bond. Therefore, when the resin is a nitrogen-containing aromatic resin, the heat resistance of the heat-resistant layer can be suitably improved. This can consequently improve the heat resistance of the nonaqueous electrolyte secondary battery separator containing the heat-resistant layer.

Preferable examples of the polyolefins include polyethylene, polypropylene, polybutene, and an ethylene-propylene copolymer.

Examples of the fluorine-containing resins include: polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoro ethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; and a fluorine-containing rubber having a glass transition temperature of not more than 23° C. among the fluorine-containing resins.

The polyamide-based resins are preferably polyamide-based resins which are nitrogen-containing aromatic resins, and particularly preferably aramid resins such as aromatic polyamides and wholly aromatic polyamides.

Specific examples of the aramid resins include poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among the above aramid resins, poly(paraphenylene terephthalamide) is more preferable.

The polyester-based resins are preferably aromatic polyesters such as polyarylates, and liquid crystal polyesters.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

Note that it is possible to use, as the resin, only one of the above resins or two or more of the above resins in combination. The resin is contained in the heat-resistant layer at a proportion of preferably 25% by weight to 80% by weight and more preferably 30% by weight to 70% by weight when the total weight of the heat-resistant layer is 100% by weight.

(Filler)

The heat-resistant layer may further contain a filler. The filler may be an inorganic filler or an organic filler. The filler is preferably an inorganic filler which is made of one or more inorganic oxides selected from the group consisting of silica, calcium oxide, magnesium oxide, titanium oxide, alumina, mica, zeolite, aluminum hydroxide, boehmite, and the like.

Note that in order to improve a water-absorbing property of the inorganic filler, it is possible to subject an inorganic filler surface to a hydrophilization treatment with, for example, a silane coupling agent.

The filler is contained, in the heat-resistant layer, at a proportion of preferably not less than 20% by weight and more preferably not less than 30% by weight (lower limit) when the total weight of the heat-resistant layer is 100% by weight. The filler is contained, in the heat-resistant layer, at a proportion of preferably not more than 80% by weight and more preferably not more than 70% by weight (upper limit) when the total weight of the heat-resistant layer is 100% by weight. Examples of a combination of the lower limit and the upper limit include 20% by weight to 80% by weight, and 30% by weight to 70% by weight. If the content of the filler is within the above range, it is possible to easily obtain a heat-resistant layer which has sufficient ion permeability.

The heat-resistant layer has a weight per unit area per layer which can be set as appropriate in view of strength, thickness, weight, and handleability of the heat-resistant layer. The weight per unit area per layer of the heat-resistant layer is preferably 0.5 g/m² to 3.5 g/m² per layer and more preferably 1.0 g/m² to 3.0 g/m² per layer of the heat-resistant layer.

When the heat-resistant layer has a weight per unit area per layer which is set to fall within the above numerical range, the nonaqueous electrolyte secondary battery including the heat-resistant layer can have a higher weight energy density and a higher volume energy density. If the weight per unit area per layer of the heat-resistant layer is beyond the above range, the nonaqueous electrolyte secondary battery including the heat-resistant layer tends to be heavy.

The heat-resistant layer has an air permeability of preferably 30 s/100 mL to 80 s/100 mL, and more preferably 40 s/100 mL to 75 s/100 mL, in terms of Gurley values. If the air permeability of the heat-resistant layer is within the above range, it can be said that the heat-resistant layer has sufficient ion permeability.

The heat-resistant layer has a porosity of preferably 20% by volume to 90% by volume, and more preferably 30% by volume to 80% by volume, in order to achieve sufficient ion permeability.

The heat-resistant layer has pores whose diameter is preferably not more than 1.0 μm, and more preferably not more than 0.5 μm. When the pores each have such a diameter, the nonaqueous electrolyte secondary battery including the heat-resistant layer can achieve sufficient ion permeability.

The heat-resistant layer has a thickness of preferably not less than 0.1 μm, more preferably not less than 0.3 μm, and still more preferably not less than 0.5 μm (lower limit). The heat-resistant layer has a thickness of preferably not more than 20 μm, more preferably not more than 10 μm, and still more preferably not more than 5 μm (upper limit). Examples of a combination of the lower limit and the upper limit of the thickness of the heat-resistant layer include 0.1 μm to 20 μm, 0.3 μm to 10 μm, and 0.5 μm to 5 μm. When the thickness of the heat-resistant layer is within the above range, it is possible to exert a sufficient function of the heat-resistant layer (e.g., to impart heat resistance) and also to reduce the total thickness of the separator.

(Examples of Preferable Combination of Resin and Filler)

In an embodiment, the resin contained in the heat-resistant layer has an intrinsic viscosity of 1.4 dL/g to 4.0 dL/g and the filler has an average particle diameter of not more than 1 μm. Use of the heat-resistant layer having such composition makes it possible to prepare a laminated separator which achieves all of heat resistance, ion permeability and reduction in thickness.

The resin in the heat-resistant layer has an intrinsic viscosity of preferably not less than 1.4 dL/g and more preferably not less than 1.5 dL/g (lower limit). The resin in the heat-resistant layer has an intrinsic viscosity of preferably not more than 4.0 dL/g, more preferably not more than 3.0 dL/g, and still more preferably not more than 2.0 dL/g (upper limit). The heat-resistant layer containing the resin having an intrinsic viscosity of not less than 1.4 dL/g can impart sufficient heat resistance to the laminated separator. The heat-resistant layer containing the resin having an intrinsic viscosity of not more than 4.0 dL/g has sufficient ion permeability.

The intrinsic viscosity can be measured, for example, by the following method.

A flow time is measured for (i) a solution in which a resin is dissolved in a concentrated sulfuric acid (96% to 98%) and (ii) the concentrated sulfuric acid (96% to 98%) in which no resin is dissolved. The following formula is used to obtain an intrinsic viscosity from the flow times thus obtained.

Intrinsic viscosity=ln(T/T₀)/C (unit: dL/g)
T: Flow time of concentrated sulfuric acid solution of resin
T₀: Flow time of concentrated sulfuric acid
C: Concentration of resin in concentrated sulfuric acid solution of resin (g/dL)

The resin having an intrinsic viscosity of 1.4 dL/g to 4.0 dL/g can be synthesized when a molecular weight distribution of the resin is adjusted by appropriately setting synthesis conditions (e.g., amount of monomers to be put in, synthesis temperature, and synthesis time). Alternatively, a commercially available resin having an intrinsic viscosity of 1.4 dL/g to 4.0 dL/g may be used. In an embodiment, the resin having an intrinsic viscosity of 1.4 dL/g to 4.0 dL/g is an aramid resin.

The filler contained in the heat-resistant layer has an average particle diameter of preferably not more than 1 μm, more preferably not more than 800 nm, still more preferably not more than 500 nm, still more preferably not more than 100 nm, and still more preferably not more than 50 nm. The average particle diameter of the filler here is an average value of sphere equivalent particle diameters of 50 particles of the filler. Further, the sphere equivalent particle diameters of the filler are each a value which is obtained by actual measurement with use of a transmission electron microscope. The following is a specific example of a measurement method.
1. An image of the filler is captured by using a transmission electron microscope (TEM; JEOL Ltd., transmission electron microscope JEM-2100F) at an acceleration voltage of 200 kV and at a magnification ratio of 10000 times with use of a Gatan Imaging Filter.
2. In the image thus obtained, an outline of a particle is traced by using image analysis software (ImageJ) and a sphere equivalent particle diameter of a filler particle (primary particle) is measured.
3. The above measurement is carried out for 50 filler particles which have been randomly extracted. The average particle diameter is an arithmetic average of sphere equivalent particle diameters of the 50 filler particles.

When the average particle diameter of the filler is set to not more than 1 μm, it is possible to reduce the thickness of the laminated separator. The average particle diameter of the filler is not particularly limited in lower limit, and can be, for example, not less than 5 nm.

[1.4. Particle Layer]

A laminated separator in accordance with an embodiment of the present invention has a particle layer on at least one side of the laminated separator. In other words, as described in the above section [1.1. Configuration of nonaqueous electrolyte secondary battery laminated separator], the particle layer may be provided at a surface of the laminated separator or another layer may be provided on the particle layer. Further, the particle layer may be provided on a surface of the polyolefin-based base material or on a surface of the heat-resistant layer.

For example, when the laminated separator has the heat-resistant layer on one surface of the polyolefin-based base material, the particle layer may be provided on the surface of the heat-resistant layer as illustrated in FIG. 3, or the particle layer may be provided on the surface which is of the polyolefin-based base material and which does not have the heat-resistant layer as illustrated in FIG. 4. Alternatively, as illustrated in FIG. 5, the particle layer may be provided on both of the surface of the polyolefin-based base material and the surface of the heat-resistant layer.

The particle layer has a weight per unit area per layer of not less than 0.1 g/m², preferably not less than 0.2 g/m², and more preferably not less than 0.25 g/m² (lower limit). Meanwhile, the particle layer has a weight per unit area per layer of not more than 1.0 g/m², preferably not more than 0.9 g/m², more preferably not more than 0.8 g/m², and still more preferably not more than 0.7 g/m² (upper limit). Having the weight per unit area per layer of the particle layer within the above range makes it possible to obtain a laminated separator excellent in ion permeability.

The weight per unit area of the particle layer is measured by comparing the weight of the laminated separator with the weight of the laminated separator from which the particle layer has been removed. The following is an example of such measurement.
1. A weight (W1) of a laminated separator that has the particle layer is measured. Further, an area (S) of the particle layer is measured.
2. The particle layer is removed from the laminated separator by cleaning with an appropriate solvent. Thereafter, the solvent is removed, for example, by drying.
3. A weight (W2) of the laminated separator from which the particle layer has been removed is measured.
4. The weight per unit area of the particle layer is calculated by the formula “(W1−W2)/S”.

Alternatively, the weight per unit area of the particle layer may be measured as in Examples of the present application, provided that the laminated separator to which the particle layer has not yet been applied is available.

The particle layer has an air permeability of preferably 0 s/100 mL to 150 s/100 mL, and more preferably 5 s/100 mL to 100 s/100 mL, in terms of Gurley values. When the particle layer has an air permeability in the above range, the base material and/or the heat-resistant layer can achieve sufficient ion permeability.

The particle layer has a porosity of preferably 1% by volume to 60% by volume, and more preferably 2% by volume to 30% by volume, so as to (i) retain a larger amount of electrolyte and (ii) obtain the function of reliably preventing a flow of an excessively large electric current at a lower temperature.

The particle layer has a thickness of preferably not less than 3 μm, more preferably not less than 3.5 μm, and still more preferably not less than 4 μm (lower limit). The particle layer has a thickness of preferably not more than 10 μm, more preferably not more than 8 μm, and still more preferably not more than 7 μm (upper limit). Examples of a combination of the lower limit and the upper limit of the thickness of the particle layer include 3 μm to 10 μm, 3.5 μm to 8 μm, and 4 μm to 7 μm.

The particle layer contains particles having an average particle diameter of not less than 3 μm, preferably not less than 3.5 μm, and more preferably not less than 4 μm (lower limit). Meanwhile, the average particle diameter of the particles contained in the particle layer is preferably not more than 10 μm, preferably not more than 8 μm, and more preferably not more than 7 μm (upper limit). When the average particle diameter of the particles contained in the particle layer is within the above range, it is possible to obtain a laminated separator excellent in voltage resistance.

The average particle diameter of the particles is a value which is obtained by actual measurement with use of a scanning electron microscope. The following is a specific example of a measurement method.
1. A scanning electron microscope (SEM) image of a surface of a particle layer is captured with use of an SEM.
2. On the SEM image thus obtained, three or more fields of view are observed with use of image analysis software, respective outlines of not less than 100 particles are traced, and a particle diameter of each of the particles is measured.
3. The arithmetic average of the particles thus measured is defined as the average particle diameter.

Examples of a monomer that is a constituent unit of a resin of which the particles are made include: vinyl chloride-based monomers such as vinyl chloride and vinylidene chloride; vinyl acetate-based monomers such as vinyl acetate; aromatic vinyl monomers such as styrene, α-methyl styrene, styrene sulfonic acid, butoxystyrene, and vinyl naphthalene; vinyl amine-based monomers such as vinyl amine; vinyl amide-based monomers such as N-vinyl formamide and N-vinyl acetamide; acid group-containing monomers such as monomers each having a carboxylic acid group, monomers each having a sulfonic acid group, monomers each having a phosphoric acid group, and monomers each having a hydroxyl group; (meth)acrylic acid derivatives such as methacrylic acid 2-hydroxyethyl; (meth)acrylic ester monomers such as methyl acrylate, ethyl acrylate, methyl methacrylate, ethyl methacrylate, and 2-ethylhexyl acrylate; (meth)acrylamide monomers such as acrylamide and methacrylamide; (meth)acrylonitrile monomers such as acrylonitrile and methacrylonitrile; fluorine-containing (meth)acrylate monomers such as 2-(perfluorohexyl)ethyl methacrylate and 2-(perfluorobutyl)ethyl acrylate; maleimides; maleimide derivatives such as phenylmaleimide; and diene-based monomers such as 1,3-butadiene and isoprene. It is possible to use one of these monomers alone or two or more of these monomers in combination at any ratio. Note that, in the specification of the present application, the “(meth)acrylic” means “acrylic” and/or “methacrylic”.

Among the above-described monomers, (meth)acrylic ester monomers are preferable. That is, the particles preferably contain an acrylic resin that contains, as a constituent unit, a (meth)acrylic ester monomer.

The proportion of a (meth)acrylic ester monomer unit contained in the acrylic resin is: preferably not less than 50% by weight, more preferably not less than 55% by weight, still more preferably not less than 60% by weight, and particularly preferably not less than 70% by weight; and preferably not more than 100% by weight, more preferably not more than 99% by weight, and still more preferably not more than 95% by weight.

Examples of the (meth)acrylic ester monomers that may form the (meth)acrylic ester monomer unit include: acrylic acid alkyl esters such as methyl acrylate, ethyl acrylate, n-propyl acrylate, isopropyl acrylate, butyl acrylate (e.g., n-butyl acrylate and t-butyl acrylate), pentyl acrylate, hexyl acrylate, heptyl acrylate, octyl acrylate (e.g., 2-ethylhexyl acrylate), nonyl acrylate, decyl acrylate, lauryl acrylate, n-tetradecyl acrylate, and stearyl acrylate; and methacrylic acid alkyl esters such as methyl methacrylate, ethyl methacrylate, n-propyl methacrylate, isopropyl methacrylate, butyl methacrylates (e.g., n-butyl methacrylate and t-butyl methacrylate), pentyl methacrylate, hexyl methacrylate, heptyl methacrylate, octyl methacrylate (e.g., 2-ethylhexyl methacrylate), nonyl methacrylate, decyl methacrylate, lauryl methacrylate, n-tetradecyl methacrylate, and stearyl methacrylate. Among these monomers, acrylic acid alkyl esters are preferable, butyl acrylate and methyl methacrylate are more preferable, and butyl acrylate is still more preferable. It is possible to use one of the (meth)acrylic ester monomers or two or more of the (meth)acrylic ester monomers in combination at any ratio.

The acrylic resin may have a unit other than the (meth)acrylic ester monomer unit. For example, the acrylic resin may contain an acid group-containing monomer unit. Examples of the acid group-containing monomer include monomers each having an acid group, for example, a monomer having a carboxylic acid group, a monomer having a sulfonic acid group, a monomer having a phosphoric acid group, and a monomer having a hydroxyl group.

Examples of the monomer having a carboxylic acid group include a monocarboxylic acid and a dicarboxylic acid. Examples of the monocarboxylic acid include acrylic acid, methacrylic acid, and crotonic acid. Examples of the dicarboxylic acid include maleic acid, fumaric acid, and itaconic acid.

Examples of the monomer having a sulfonic acid group include vinyl sulfonic acid, methylvinyl sulfonic acid, (meth)allyl sulfonic acid, (meth)acrylic acid 2-ethyl sulfonate, 2-acrylamido-2-methylpropane sulfonic acid, and 3-allyloxy-2-hydroxypropane sulfonic acid.

Examples of the monomer having a phosphoric acid group include 2-(meth)acryloyloxyethyl phosphate, methyl-2-(meth)acryloyloxyethyl phosphate, and ethyl-(meth)acryloyloxyethyl phosphate.

Examples of the monomer having a hydroxyl group include 2-hydroxyethyl acrylate, 2-hydroxypropyl acrylate, 2-hydroxyethyl methacrylate, and 2-hydroxypropyl methacrylate.

Among these monomers, the acid group-containing monomer is preferably a monomer having a carboxylic acid group. Among monomers each having a carboxylic acid group, the monomer having a carboxylic acid group is preferably a monocarboxylic acid and more preferably a (meth)acrylic acid. It is possible to use one of those acid group-containing monomers alone or two or more of the acid group-containing monomers in combination at any ratio.

The proportion of the acid group-containing monomer unit in the acrylic resin is: preferably not less than 0.1% by weight, more preferably not less than 1% by weight, and still more preferably not less than 3% by weight; and preferably not more than 20% by weight, more preferably not more than 10% by weight, and still more preferably not more than 7% by weight.

The acrylic resin preferably contains a cross-linkable monomer unit in addition to the above monomer unit. A cross-linkable monomer is a monomer which, upon heating or irradiation with an energy beam, can form a cross-linked structure during or after polymerization. Inclusion of the cross-linkable monomer unit makes it possible to easily keep a degree of swelling of the polymer in a specific range.

Examples of the cross-linkable monomer include a multifunctional monomer which has two or more polymerization reactive groups in the monomer. Examples of such a multifunctional monomer include: divinyl compounds such as divinylbenzene; di(meth)acrylic ester compounds such as diethylene glycol dimethacrylate, ethylene glycol dimethacrylate, diethylene glycol diacrylate, and 1,3-butylene glycol diacrylate; tri(meth)acrylic ester compounds such as trimethylolpropane trimethacrylate and trimethylolpropane triacrylate; and ethylenically unsaturated monomers each containing an epoxy group such as allyl glycidyl ether and glycidyl methacrylate. Among these monomers, dimethacrylic ester compounds and ethylenically unsaturated monomers each containing an epoxy group are preferable, and the dimethacrylic ester compounds are more preferable. It is possible to use one of the above monomers alone or two or more of the above monomers in combination at any ratio.

A specific proportion of the cross-linkable monomer unit in the acrylic resin is: preferably not less than 0.1% by weight, more preferably not less than 0.2% by weight, and still more preferably not less than 0.5% by weight; and preferably not more than 5% by weight, more preferably not more than 4% by weight, and still more preferably not more than 3% by weight.

The particles are not particularly limited in structure as long as the structure can achieve the above-described predetermined average particle diameter. Examples of the structure include a structure in which individual polymers having a particle shape exist separately, a structure in which individual polymers having a particle shape exist in contact with each other, and a structure in which individual polymers having a particle shape exist in a complexed form.

When the individual particles are present in contact with each other or in a complexed form, the particles may have, for example, a core-shell structure. The core-shell structure may have a shell that covers the entire outer surface of a core or a shell that partially covers the outer surface of the core. In view of ion permeability, the shell preferably partially covers the core. In each of the particles that have a core-shell structure in which the shell partially covers the core, it is preferable that there be two types of particles, that is, a core particle and shell particles, and that the shell particles cover the outer surface of the core particle. When the particles have a core-shell structure, the average particle diameter of the particles refers to an average of respective particle diameters of whole particles each of which has the core-shell structure.

The following will discuss the particle in which the shell particle covers the outer surface of the core particle, with reference to FIG. 6. A particle 10 is a whole particle that has a core-shell structure which includes a core particle 20 and shell particles 30. Here, the core particle 20 is a portion on an inner side of the shell particles 30 in the particle 10. Further, the shell particles 30 are portions which cover an outer surface 20a of the core particle 20 and are generally outermost portions of the particle 10.

It is possible to measure, from an observation result of a cross-sectional structure of a particle that has a core-shell structure, an average proportion at which the shell particles cover the outer surface of the core particle. The following describes a specific measurement method.
1. Particles are sufficiently dispersed in an epoxy resin which is curable at normal temperature, and then embedded in the epoxy resin, so that a block piece containing the particles is prepared.
2. The block piece thus prepared is cut out into a flake having a thickness of 80 nm to 200 nm by using a microtome that is provided with a diamond blade, so that a measurement sample is prepared. Thereafter, if necessary, the measurement sample is subjected to a dyeing treatment with use of, for example, ruthenium tetraoxide or osmium tetraoxide.
3. The measurement sample thus obtained is set in a transmission electron microscope (TEM) and an image of a cross-sectional structure of a particle is captured. The magnification ratio of the electron microscope is preferably a ratio at which a cross section of one particle enters the field of view, and specifically preferably approximately 10,000 times.
4. In the cross-sectional structure of the particle whose image has been captured, measured are a length D1 of a circumference that corresponds to an outer surface of the core particle and a length D2 of a portion where the outer surface of the core particle abuts on the shell particles. Next, with use of the length D1 and the length D2 that have been measured, a ratio Rc at which the outer surface of the core particle of the particle is covered by the shell particles is calculated by the following formula (1).

Surface coverage Rc (%)=(D2/D1)×100 (1)
5. The surface coverage Rc is measured for not less than 20 particles, and an average value of surface coverages thus measured is calculated. Then, the average value is considered as an average ratio (surface coverage) at which the shell particles cover the outer surface of the core particle.

The surface coverage Rc can be calculated manually from the cross-sectional structure, but can also be calculated by using commercially available image analysis software. As such commercially available image analysis software, for example, “AnalySISPro” (produced by Olympus Corporation) can be used.

When the particle has a core-shell structure, the core particle preferably contains the above-described acrylic resin. The acrylic resin is contained, in the core particle, at a proportion of preferably not less than 70% by weight, more preferably not less than 80% by weight, and still more preferably not less than 90% by weight (lower limit). The acrylic resin may be contained, in the core particle, at a proportion of not more than 100% by weight (upper limit).

When the particles have a core-shell structure, it is preferable to use an aromatic vinyl monomer as a monomer that is to be used for preparing a polymer of the shell particles. In other words, the polymer of the shell particles preferably contains an aromatic vinyl resin. Among the aromatic vinyl monomers, styrene and styrene derivatives such as styrene sulfonic acid are more preferable. The aromatic vinyl resin is contained, in the shell particles, at a proportion of preferably not less than 70% by weight, more preferably not less than 80% by weight, and still more preferably not less than 90% by weight (lower limit). The aromatic vinyl resin may be contained, in the shell particles, at a proportion of not more than 100% by weight (upper limit).

The proportion of the aromatic vinyl monomer unit in the polymer of the shell particles is: preferably not less than 20% by weight, more preferably not less than 40% by weight, still more preferably not less than 50% by weight, and further more preferably not less than 60% by weight, and particularly preferably not less than 80% by weight; and preferably not more than 100% by weight, more preferably not more than 99.5% by weight, and still more preferably not more than 99% by weight.

Further, the polymer of the shell particles may contain, in addition to the aromatic vinyl monomer unit, an acid group-containing monomer unit. Examples of the acid group-containing monomer include monomers each having an acid group, for example, a monomer having a carboxylic acid group, a monomer having a sulfonic acid group, a monomer having a phosphoric acid group, and a monomer having a hydroxyl group. Specific examples of the acid group-containing monomer include the same monomers as those of the acid group-containing monomer that may be contained in the core particle.

Among these monomers, the acid group-containing monomer is preferably a monomer having a carboxylic acid group. Among monomers each having a carboxylic acid group, the monomer having a carboxylic acid group is preferably a monocarboxylic acid and more preferably a (meth)acrylic acid. It is possible to use one of those acid group-containing monomers alone or two or more of the acid group-containing monomers in combination at any ratio.

The proportion of the acid group-containing monomer unit in the polymer of the shell particles is: preferably not less than 0.1% by weight, more preferably not less than 1% by weight, and still more preferably not less than 3% by weight; and preferably not more than 20% by weight, more preferably not more than 10% by weight, and still more preferably not more than 7% by weight. When the proportion of the acid group-containing monomer unit is within the above range, it is possible to improve dispersibility of composite particles and dispersibility of the particles in the particle layer and to express good adhesiveness all over the surface of the particle layer.

Also, the polymer of the shell particles may contain a cross-linkable monomer unit. Examples of such a cross-linkable monomer include the same monomers as those of the cross-linkable monomer that can be used for the polymer of the core particle. Further, it is possible to use one of such cross-linkable monomers alone or two or more of the cross-linkable monomers in combination at any ratio.

A specific proportion of the cross-linkable monomer unit in the polymer of the shell particles is preferably not less than 0.1% by weight, more preferably not less than 0.2% by weight, and still more preferably not less than 0.5% by weight; and preferably not more than 5% by weight, more preferably not more than 4% by weight, and still more preferably not more than 3% by weight.

Even when the core-shell structure, the core particle, and the shell particles are not configured in a manner described in the specification of the present application, it is possible to select and employ, as appropriate, for example, a configuration disclosed in Japanese Patent No. 6413419.

2. Physical Properties of Nonaqueous Electrolyte Secondary Battery Laminated Separator

[2.1. Air Permeability]

The laminated separator has an air permeability of preferably not more than 500 s/100 mL, and more preferably not more than 400 s/100 mL, and still more preferably not more than 300 s/100 mL, in terms of Gurley values. It can be said that the laminated separator having an air permeability within the above range has sufficient ion permeability. See Examples of the present application for the details of a measurement method.

[2.2. Withstand Voltage]

The laminated separator preferably has a withstand voltage of not less than 1.65 kV/mm and more preferably not less than 1.70 kV/mm. See Examples of the present application for the details of a measurement method.

[2.3. Other Physical Properties]

(Porosity)

The laminated separator has a porosity of preferably 20% by volume to 80% by volume, more preferably 30% by volume to 70% by volume, and still more preferably 40% by volume to 60% by volume, so as to (i) retain a larger amount of an electrolyte and (ii) obtain the function of reliably preventing a flow of an excessively large electric current at a lower temperature.

3. Method for Producing Nonaqueous Electrolyte Secondary Battery Laminated Separator]

[Method for Producing Polyolefin-Based Base Material]

The following method is an example of a method for producing the polyolefin-based base material. That is, first, a polyolefin-based resin is kneaded together with a pore forming agent such as an inorganic bulking agent or a plasticizer, and optionally with another agent(s) such as an antioxidant, so as to produce a polyolefin-based resin composition. Then, the polyolefin-based resin composition is extruded, so that a polyolefin-based resin composition in a sheet form is prepared. Further, the pore forming agent is removed from the polyolefin-based resin composition in the sheet form with use of an appropriate solvent. Thereafter, the polyolefin-based base material can be produced by stretching the polyolefin-based resin composition from which the pore forming agent has been removed.

The inorganic bulking agent is not particularly limited. Examples of the inorganic bulking agent include inorganic fillers; one specific example is calcium carbonate. The plasticizer is not particularly limited. The plasticizer can be a low molecular weight hydrocarbon such as liquid paraffin.

The method for producing the polyolefin-based base material can be, for example, a method including the following steps of:
(i) obtaining a polyolefin-based resin composition by kneading an ultra-high molecular weight polyethylene having a weight-average molecular weight of not less than 1,000,000, a low molecular weight polyethylene having a weight-average molecular weight of not more than 10,000, a pore forming agent such as calcium carbonate or a plasticizer, and an antioxidant;
(ii) forming a sheet by cooling, in stages, the polyolefin-based resin composition obtained;
(iii) removing, with use of an appropriate solvent, the pore forming agent from the sheet obtained; and
(iv) stretching, at an appropriate stretch ratio, the sheet from which the pore forming agent has been removed.

(Method for Producing Heat-Resistant Layer)

The heat-resistant layer can be formed with use of a coating solution in which the resin described in the section [1.3. Heat-resistant layer] is dissolved or dispersed in a solvent. Further, the heat-resistant layer containing the resin and the filler can be formed with use of a coating solution which is obtained by (i) dissolving or dispersing the resin in a solvent and (ii) dispersing the filler in the solvent.

Note that the solvent can be a solvent in which the resin is to be dissolved. Further, the solvent can be a dispersion medium in which the resin or the filler is to be dispersed. Examples of a method for forming the coating solution include a mechanical stirring method, an ultrasonic dispersion method, a high-pressure dispersion method, and a media dispersion method.

Examples of the method for forming the heat-resistant layer include: a method in which the coating solution is applied directly to a surface of a base material and then the solvent is removed; a method in which (i) the coating solution is applied to an appropriate support, (ii) the solvent is removed so that the heat-resistant layer is formed, (iii) the heat-resistant layer and the base material are bonded together by pressure, and then (iv) the support is peeled off; a method in which (i) the coating solution is applied to an appropriate support, (ii) the base material is bonded to a resultant coated surface by pressure, (iii) the support is peeled off, and then (iv) the solvent is removed; and a method in which dip coating is carried out by immersing the base material in the coating solution, and then the solvent is removed.

It is preferable that the solvent be a solvent which (i) does not adversely affect the base material, (ii) allows the resin to be dissolved uniformly and stably, and (iii) allows the filler to be dispersed uniformly and stably. The solvent can be one or more solvents selected from the group consisting of, for example, N-methyl-2-pyrrolidone, N,N-dimethylacetamide, N,N-dimethylformamide, acetone, and water.

The coating solution can contain, as a component other than the above-described resin and the filler, for example, a disperser, a plasticizer, a surfactant, and a pH adjustor, when appropriate.

The coating solution can be applied to the base material by a conventionally known method. Specific examples of such a method include a gravure coater method, a dip coater method, a bar coater method, and a die coater method.

If the coating solution contains an aramid resin, the aramid resin can be deposited by applying humidity to the coated surface. The heat-resistant layer can be formed in this way.

The solvent can be removed from the coating solution which has been applied to the base material, for example, by a method in which the solvent is removed, by air blow drying or heat drying, from a coating film which is a film of the coating solution.

Further, the porosity and the average pore diameter of the heat-resistant layer to be obtained can be adjusted by changing an amount of the solvent in the coating solution.

A suitable solid content concentration of the coating solution may vary depending on, for example, kinds of the filler, but generally, the solid content concentration is preferably higher than 3% by weight and not higher than 40% by weight.

When the base material is coated with the coating solution, a coating shear rate may vary depending on, for example, kinds of the filler. Generally, the coating shear rate is preferably not lower than 2 (l/s) and more preferably in the range of 4 (l/s) to 50 (l/s).

(Method for Preparing Aramid Resin)

Examples of a method for preparing the aramid resin include, but are not particularly limited to, condensation polymerization of para-oriented aromatic diamine and para-oriented aromatic dicarboxylic acid halide. In such a method, the aramid resin obtained is substantially composed of repeating units in which amide bonds occur at para or quasi-para positions of the aromatic ring. “Quasi-para positions” refers to positions at which bonds extend in opposing directions from each other, coaxially or in parallel, such as 4 and 4′ positions of biphenylene, 1 and 5 positions of naphthalene, and 2 and 6 positions of naphthalene.

A solution of poly(paraphenylene terephthalamide) can be prepared by, for example, a method including the following specific steps (I) through (IV).
(I) N-methyl-2-pyrrolidone is introduced into a dried flask. Then, calcium chloride which has been dried at 200° C. for 2 hours is added. Then, the flask is heated to 100° C. to completely dissolve the calcium chloride.
(II) The solution obtained in the step (I) is returned to room temperature, and then paraphenylenediamine is added and completely dissolved.
(III) While a temperature of the solution obtained in the step (II) is maintained at 20±2° C., terephthalic acid dichloride is divided into 10 separate identical portions and the 10 portions of the terephthalic acid dichloride are added at approximately 5-minute intervals.
(IV) While a temperature of the solution obtained in the step (III) is maintained at 20±2° C., the solution is aged for 1 hour, and is then stirred under reduced pressure for 30 minutes to eliminate air bubbles, so that the solution of the poly(paraphenylene terephthalamide) is obtained.

(Method for Producing Particle Layer)

The particle layer can be formed by applying, to the base material or to the heat-resistant layer, a slurry that contains the above-described particles, and then drying the base material. The slurry may contain another component in addition to the above-described particles. Examples of such another component include a binder, a disperser, and a wetting agent.

In forming the particle layer, a method for applying and drying the slurry is not particularly limited. Examples of the method for applying the slurry include a gravure coater method, a dip coater method, a bar coater method, and a die coater method. Meanwhile, examples of the method for drying the slurry include drying by warm air, hot air or low humidity air, vacuum drying, and drying by irradiation with (far) infrared rays or electron rays. The temperature at which the slurry applied is dried can be varied depending on a type of the solvent used.

4. Nonaqueous Electrolyte Secondary Battery Member and Nonaqueous Electrolyte Secondary Battery

In a member for a nonaqueous electrolyte secondary battery (herein also referred to as a “nonaqueous electrolyte secondary battery member”) in accordance with an aspect of the present invention, a positive electrode, the above-described separator, and a negative electrode are arranged in this order. A nonaqueous electrolyte secondary battery in accordance with an aspect of the present invention includes the above-described separator.

The nonaqueous electrolyte secondary battery is not particularly limited in shape and can have any shape such as the shape of a thin plate (sheet), a disk, a cylinder, or a prism such as a cuboid. The nonaqueous electrolyte secondary battery is, for example, a nonaqueous electrolyte secondary battery that achieves an electromotive force through doping with and dedoping of lithium. The nonaqueous electrolyte secondary battery includes the nonaqueous electrolyte secondary battery member which is made of a positive electrode, the above-described separator, and a negative electrode formed in this order. Note that components of the nonaqueous electrolyte secondary battery other than the above-described separator are not limited to those described below.

The nonaqueous electrolyte secondary battery is generally structured such that a battery element is enclosed in an exterior member, the battery element including (i) a structure in which the negative electrode and the positive electrode face each other via the above-described separator and (ii) an electrolyte with which the structure is impregnated. Note that the doping means occlusion, support, adsorption, or insertion, and means a phenomenon in which lithium ions enter an active material of an electrode (e.g., a positive electrode).

Since the nonaqueous electrolyte secondary battery member includes the above-described separator, the nonaqueous electrolyte secondary battery member, when incorporated in the nonaqueous electrolyte secondary battery, can suppress the occurrence of a micro short circuit of the nonaqueous electrolyte secondary battery and consequently can improve safety of the nonaqueous electrolyte secondary battery. Further, since the nonaqueous electrolyte secondary battery includes the above-described separator, the nonaqueous electrolyte secondary battery can suppress the occurrence of a micro short circuit and is excellent in safety.

[4.1. Positive Electrode]

The positive electrode employed in an embodiment of the present invention is not limited to any particular one, provided that the positive electrode is one that is generally used as a positive electrode of a nonaqueous electrolyte secondary battery. Examples of the positive electrode include a positive electrode sheet having a structure in which an active material layer, containing a positive electrode active material and a binding agent, is formed on a positive electrode current collector. Note that the active material layer may further contain an electrically conductive agent and/or a binding agent.

Examples of the positive electrode active material include materials each capable of being doped with and dedoped of lithium ions. Specific examples of the materials include lithium complex oxides each containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound. It is possible to use only one of the above electrically conductive agents, or two or more of the above electrically conductive agents in combination.

Examples of the binding agent include: fluorine-based resins such as polyvinylidene fluoride (PVDF); acrylic resin; and styrene butadiene rubber. Note that the binding agent serves also as a thickener.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet includes: a method in which the positive electrode active material, the electrically conductive agent, and the binding agent are pressure-molded on the positive electrode current collector; and a method in which (i) the positive electrode active material, the electrically conductive agent, and the binding agent are formed into a paste with use of an appropriate organic solvent, (ii) the positive electrode current collector is coated with the paste, and (iii) the paste is dried and then pressured so that the paste is firmly fixed to the positive electrode current collector.

[4.2. Negative Electrode]

The negative electrode employed in an embodiment of the present invention is not limited to any particular one, provided that the negative electrode is one that is generally used as a negative electrode of a nonaqueous electrolyte secondary battery. Examples of the negative electrode include a negative electrode sheet having a structure in which an active material layer, containing a negative electrode active material and a binding agent, is formed on a negative electrode current collector. Note that the active material layer may further contain an electrically conductive agent and/or a binding agent.

Examples of the negative electrode active material include materials each capable of being doped with and dedoped of lithium ions. Examples of the materials include carbonaceous materials. Examples of the carbonaceous materials include natural graphite, artificial graphite, cokes, carbon black, and pyrolytic carbons.

Examples of the negative electrode current collector include Cu, Ni, and stainless steel. Among these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressure is applied so that the paste is firmly fixed to the negative electrode current collector. The paste preferably contains the above-described electrically conductive agent and the binding agent as described above.

[4.3. Nonaqueous Electrolyte]

A nonaqueous electrolyte in an embodiment of the present invention is not limited to any particular one, provided that the nonaqueous electrolyte is one that is generally used for a nonaqueous electrolyte secondary battery such as a lithium ion secondary battery. The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one of the above lithium salts or two or more of the above lithium salts in combination.

Examples of the organic solvent to be contained in the nonaqueous electrolyte include carbonates, ethers, esters, nitriles, amides, carbamates, sulfur-containing compounds, and fluorine-containing organic solvents each obtained by introducing a fluorine group into any of these organic solvents. It is possible to use only one of the above organic solvents or two or more of the above organic solvents in combination.

[4.4. Method of Producing Nonaqueous Electrolyte Secondary Battery]

The nonaqueous electrolyte secondary battery can be produced by a conventionally known method. For example, first, the nonaqueous electrolyte secondary battery member is formed by providing a positive electrode, the separator, and a negative electrode in this order. Next, the nonaqueous electrolyte secondary battery member is inserted into a container which serves as a housing for the nonaqueous electrolyte secondary battery. Further, the container is filled with a nonaqueous electrolyte, and then hermetically sealed while pressure is reduced in the container. In this way, the nonaqueous electrolyte secondary battery can be produced.

5. Aspects of the Present Invention can Also be Expressed as Follows:

The present invention encompasses the following aspects.

<1>

A nonaqueous electrolyte secondary battery laminated separator having a heat-resistant layer on one surface or both surfaces of a polyolefin-based base material, the nonaqueous electrolyte secondary battery laminated separator including
a particle layer on at least one side of the laminated separator,
the particle layer containing particles having an average particle diameter of 3 μm to 10 μm, and
the particle layer having a weight per unit area per layer of 0.1 g/m² to 1.0 g/m².
   <2>

The laminated separator according to <1>, wherein the heat-resistant layer contains an aromatic resin.

<3>

The laminated separator according to <1> or <2>, wherein the particles contain an acrylic resin.

<4>

The laminated separator according to any one of <1> to <3>, wherein the particles each has a core-shell structure.

<5>

The laminated separator according to <4>, wherein the core-shell structure contains a core particle and a shell particle that are two types of particles.

<6>

A nonaqueous electrolyte secondary battery member, comprising a positive electrode, a laminated separator described in any one of <1> to <5>, and a negative electrode, which are formed in this order.

<7>

A nonaqueous electrolyte secondary battery, including a laminated separator described in any one of <1> to <5>.

<8>

A nonaqueous electrolyte secondary battery, including a nonaqueous electrolyte secondary battery member described in <6>.

### EXAMPLES

The following description will discuss embodiments of the present invention in greater detail with reference to Examples and Comparative Examples. Note, however, that the present invention is not limited to the following Examples.

[Measurements of Physical Properties]

(1) Average Particle Diameter of Particles (Unit: μm)

The following procedure was used to measure an average particle diameter of particles.
1. A scanning electron microscope (SEM) image of a surface of a particle layer was captured with use of an SEM.
2. On the SEM image thus obtained, three or more fields of view were observed with use of image analysis software (ImageJ), respective outlines of not less than 100 particles were traced, and a particle diameter of each of the particles was measured.
3. The arithmetic average of the particles thus measured was defined as the average particle diameter.

(2) Weight Per Unit Area of Particle Layer (Unit: g/m²)

The following procedure was used to measure a weight per unit area of the particle layer.
1. A square sample measuring 10 cm×10 cm was cut out from a laminated separator of each of the Examples and Comparative Examples described below, and a weight W1 (g) of the sample was measured.
2. A square sample measuring 10 cm×10 cm was cut out from a heat-resistant separator of each of Examples and Comparative Examples described below, and a weight W2 (g) of the sample was measured.
3. The weight per unit area (g/m²) of the particle layer was calculated according to the following Formula (1) with use of the values of W1 and W2 thus measured.

Weight per unit area of particle layer=(W1−W2)/(0.10×0.10) Formula (1)

(3) Air Permeability of Laminated Separator (Unit: s/100 mL)

An air permeability (Gurley values) of the laminated separator of each of the Examples and Comparative Examples was measured in accordance with JIS P8117 with use of EG01-5-1MR manufactured by Asahi Seiko Co., Ltd.

(4) Withstand Voltage of Laminated Separator (Unit: kV/mm)

A cylindrical electrode probe (100 g) having a diameter of Φ8 mm as shown in FIG. 7 was placed on the laminated separator of each of the Examples and Comparative Examples. Subsequently, a weight of 400 g was placed on the electrode probe. Thereafter, a breakdown voltage was measured at a voltage increase rate of 25 V/s with use of a withstand voltage tester (TOS9200 manufactured by KIKUSUI Corporation). A value of the breakdown voltage thus measured was considered as a value of withstand voltage (voltage resistance).

Note that the withstand voltage test simulates an aspect in which a voltage is applied while a load is applied to a laminated separator during charging and discharging of an actual nonaqueous electrolyte secondary battery. Therefore, if the value of the withstand voltage measured in the withstand voltage test is high, the laminated separator exhibits good voltage resistance during charging and discharging of the actual nonaqueous electrolyte secondary battery.

[Production Example of Aramid Polymerization Liquid]

Poly(paraphenylene terephthalamide) was produced with use of a 3-liter separable flask having a stirring blade, a thermometer, a nitrogen inlet pipe, and a powder addition port.

The flask was sufficiently dried. Into the flask, 2200 g of N-methyl-2-pyrrolidone (NMP) was introduced. Then, 151.07 g of calcium chloride powder, which had been vacuum-dried at 200° C. for 2 hours, was added, and the temperature of the NMP was increased to 100° C. As a result, the calcium chloride powder was completely dissolved. After the temperature of a solution thus obtained was returned to room temperature, 68.23 g of paraphenylenediamine was added and the paraphenylenediamine was completely dissolved. While the temperature of the solution thus obtained was maintained at 20° C.±2° C. and the dissolved oxygen concentration during polymerization was maintained at 0.5%, 124.97 g of terephthalic acid dichloride was divided into 10 separate identical portions and the 10 portions of the terephthalic acid dichloride were added at approximately 5-minute intervals. Thereafter, while the temperature of the solution was maintained at 20° C.±2° C., the solution was aged for 1 hour while being stirred. Subsequently, the solution thus aged was filtrated through a 1500-mesh stainless steel gauze. A resultant solution was a para-aramid solution having a para-aramid concentration of 6%.

### Example 1

In a flask, 100 g of the para-aramid solution that had been obtained in the above [Production example of aramid polymerization liquid] was weighed out. Then, 166.7 g of NMP was added, so that a para-aramid solution having a para-aramid concentration of 2.25% by weight was prepared. This solution was stirred for 60 minutes. Subsequently, 6 g of Alumina C (manufactured by Nippon Aerosil Co., Ltd.) was mixed with the solution, and then stirring was carried out for 240 minutes. The solution thus obtained was filtrated through a 1000-mesh wire gauze. Then, 0.73 g of calcium carbonate was added and stirring was carried out for 240 minutes, so that the solution was neutralized. Further, defoaming was carried out under reduced pressure, so that a coating solution (1) was prepared.

The coating solution (1) was applied, by a doctor blade method, onto a base material (thickness: 10.4 μm, and porosity: 43%) that was made of polyethylene. A resultant coated material (1) was left to stand still in the air at 50° C. and at a relative humidity of 70% for 1 minute, so that a layer containing poly(paraphenylene terephthalamide) was deposited. Next, the coated material (1) was immersed in ion-exchange water, so that calcium chloride and a solvent were removed. Thereafter, the coated material (1) was dried in an oven at 80° C., and a heat-resistant separator (1) was obtained in which an aramid heat-resistant layer was formed on the base material.

Organic particles (PX-SA02, manufactured by Zeon Corporation) made of a styrene-acrylic cross-linked polymer compound having an average particle diameter of 4.8 μm and ultrapure water as a solvent were mixed at a weight ratio of 3:97, so that a slurry (1) was obtained.

The slurry (1) was applied, with use of a coater, onto a surface which was of the heat-resistant separator (1) and on which the aramid heat-resistant layer was formed. The slurry (1) was applied so that the weight per unit area per layer of the particle layer could be 0.2 g/m². After coating, the slurry (1) was dried at 50° C. in a dryer, so that a laminated separator (1) was obtained.

### Example 2

A laminated separator (2) was obtained as in Example 1, except that the weight per unit area per layer of the particle layer was adjusted to 0.3 g/m².

### Example 3

A laminated separator (3) was obtained as in Example 1, except that the weight per unit area per layer of the particle layer was adjusted to 1.0 g/m².

### Example 4

Organic particles (PX-SA05, manufactured by Zeon Corporation) made of a styrene-acrylic cross-linked polymer compound having an average particle diameter of 3.2 μm and ultrapure water as a solvent were mixed at a weight ratio of 3:97, so that a slurry (2) was obtained.

The slurry (2) was applied, with use of a coater, onto a surface which was of the heat-resistant separator (1) and on which the aramid heat-resistant layer was formed. The slurry (2) was applied so that the weight per unit area per layer of the particle layer could be 0.3 g/m². After coating, the slurry (2) was dried at 50° C. in a dryer, so that a laminated separator (4) was obtained.

### Comparative Example 1

The heat-resistant separator (1) prepared in Example 1 was used as a laminated separator (C1).

### Comparative Example 2

A laminated separator (C2) was obtained as in Example 1, except that the weight per unit area per layer of the particle layer was adjusted to 1.7 g/m².

### Comparative Example 3

A laminated separator (C3) was obtained as in Example 1, except that organic compound particles (PX-SA01, manufactured by Zeon Corporation) made of a styrene-acrylic cross-linked polymer compound having an average particle diameter of 0.65 μm was used as particles contained in the particle layer and the weight per unit area per layer of the particle layer was adjusted to 0.3 g/m².

TABLE 1

| | | | | Average | Weight | | |
|---|---|---|---|---|---|---|---|
| | Configuration of laminated | | | particle | per unit | | |
| | separator | | | diameter | area of | Effect | |
| | Polyolefin- | Heat- | | of | particle | Air | Withstand |
| | based base | resistant | Particle | particles | layer | permeability | voltage |
| | material | layer | layer | (μm) | (g/m²) | (s/100 mL) | (kV/mm) |
| Example 1 | polyethylene | single | single | 4.8 | 0.2 | 278 | 1.66 |
| | base | surface | surface | | | | |
| | material | | | | | | |
| Example 2 | polyethylene | single | single | 4.8 | 0.3 | 285 | 1.74 |
| | base | surface | surface | | | | |
| | material | | | | | | |
| Example 3 | polyethylene | single | single | 4.8 | 1 | 383 | 1.96 |
| | base | surface | surface | | | | |
| | material | | | | | | |
| Example 4 | polyethylene | single | single | 3.2 | 0.3 | 265 | 1.79 |
| | base | surface | surface | | | | |
| | material | | | | | | |
| Comparative | polyethylene | single | — | — | — | 271 | 1.61 |
| Example 1 | base | surface | | | | | |
| | material | | | | | | |
| Comparative | polyethylene | single | single | 4.8 | 1.7 | 538 | 1.83 |
| Example 2 | base | surface | surface | | | | |
| | material | | | | | | |
| Comparative | polyethylene | single | single | 0.65 | 0.3 | 281 | 1.56 |
| Example 3 | base | surface | surface | | | | |
| | material | | | | | | |

[Results]

It is clear, from a comparison of each of Examples 1 to 4 with Comparative Example 1, that providing the particle layer improves the voltage resistance of the laminated separator. On the other hand, it is understood, from the comparison of each of Examples 1 to 4 with Comparative Example 1, that when the particle layer is provided, the ion permeability tends to decrease. However, this decrease in ion permeability is within an acceptable range.

Moreover, it is clear, from a comparison of each of Examples 1 to 4 with Comparative Example 2, that although the Gurley value tends to increase (the ion permeability tends to decrease) as the weight per unit area of the particle layer increases, sufficient ion permeability can be ensured if the weight per unit area of the particle layer is not more than 1.0 g/m².

Further, it is clear, from a comparison of each of Examples 1 to 4 with Comparative Example 3, that the effect of improving voltage resistance can be obtained if the average particle diameter of the particles contained in the particle layer is in the range of 3 μm to 10 μm. It is also clear that on the contrary, if the average particle diameter of the particles contained in the particle layer is less than 3 μm, the effect of improving the voltage resistance cannot be obtained.

### INDUSTRIAL APPLICABILITY

A nonaqueous electrolyte secondary battery separator in accordance with an embodiment of the present invention can be used for production of a nonaqueous electrolyte secondary battery which can suppress the occurrence of a micro short circuit during charging and discharging and which is excellent in safety.

### REFERENCE SIGNS LIST

1: polyolefin-based base material
2, 2a, 2b: heat-resistant layer
3, 3a, 3b: particle layer
4a, 4b, 4c, 4d, 4e: laminated separator
10: particles
20: core particle
20a: outer surface of core particle
30: shell particles

1. A nonaqueous electrolyte secondary battery laminated separator having a heat-resistant layer on one surface or both surfaces of a polyolefin-based base material, the nonaqueous electrolyte secondary battery laminated separator comprising
a particle layer on at least one side of the laminated separator,
the particle layer containing particles having an average particle diameter of 3 μm to 10 μm, and
the particle layer having a weight per unit area per layer of 0.1 g/m² to 1.0 g/m².

2. The laminated separator according to claim 1, wherein the heat-resistant layer contains an aromatic resin.

3. The laminated separator according to claim 1, wherein the particles contain an acrylic resin.

4. The laminated separator according to claim 1, wherein the particles each has a core-shell structure.

5. The laminated separator according to claim 4, wherein the core-shell structure contains a core particle and a shell particle that are two types of particles.

6. A nonaqueous electrolyte secondary battery member, comprising a positive electrode, a laminated separator recited in claim 1, and a negative electrode, which are formed in this order.

7. A nonaqueous electrolyte secondary battery, including a laminated separator recited in claim 1.

8. A nonaqueous electrolyte secondary battery, comprising a nonaqueous electrolyte secondary battery member recited in claim 6.
